(19) United States
(12) Patent Application Publication
(10) Pub. No.: US 2010/0307849 A1
(43) Pub. Date: Dec. 9, 2010

(54) VEHICLE DRIVEN BY COMPRESSED AIR AND AIR COMPRESSOR

(76) Inventor: Jianquan Li, Hainan (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/864,630

(22) PCT Filed: Jan. 29, 2008
(86) PCT No.: PCT/CN08/70203

§ 371 Date: Jul. 26, 2010

(51) Int. Cl. B60K 25/10

(52) U.S. Cl. 180/165

(57) ABSTRACT

A vehicle, driven by compressed air, includes at least one air compressor, an air reservoir, and an air-propelled motor. The at least one air compressor, which is positioned between a body and a wheel axle of the vehicle, is configured to generate compressed air responding to vibrations of the wheel axle caused by irregularities in the road surface. The air reservoir, which is connected to the air-compressor, is configured to reserve the compressed air. The air-propelled motor, which is connected to the air reservoir, is driven by the compressed air.

### BACKGROUND OF THE INVENTION

1. Field of the Invention

The present disclosure relates generally to vehicles, and more particularly, to a vehicle driven by compressed air and an air compressor used by the vehicle.

2. Description of the Related Art

Vehicles, such as automobiles and motorcycles, typically include wheels which are driven by a motor engine. Typical vehicles utilize a fuel, such as gasoline, which explodes in cylinders and the explosion causes a crank shaft to turn. This approach is utilized in the well known internal combustion engine, the diesel engine, as well as the rotary piston engine.

Such engines utilizing fuel, such as gasoline, produce a great amount of exhaust gas and fumes which tend to pollute the atmosphere.

Therefore, there is room for improvement within the art.

### SUMMARY OF THE INVENTION

It is an object of the present disclosure to provide a vehicle driven by compressed air generated by vibrations of the wheel axle caused by irregularities in the road surface, thus reducing the consumption of the gasoline and the pollution to the atmosphere.

A vehicle, driven by compressed air, includes at least one air compressor, positioned between a body and a wheel axle of the vehicle, configured to generate compressed air responding to vibrations of the wheel axle caused by irregularities in the road surface; an air reservoir, connected to the air-compressor, configured to reserve the compressed air; an air-propelled motor, connected to the air reservoir, driven by the compressed air.

An air compressor, positioned between a body and a wheel axle of a vehicle, configured to generate compressed air responding to vibrations of the wheel axle caused by irregularities in the road surface.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a diagrammatic drawing showing an embodiment of a vehicle of the present disclosure.

FIG. 2 is a schematic view of an embodiment of an air compressor used in a vehicle, such as, for example, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

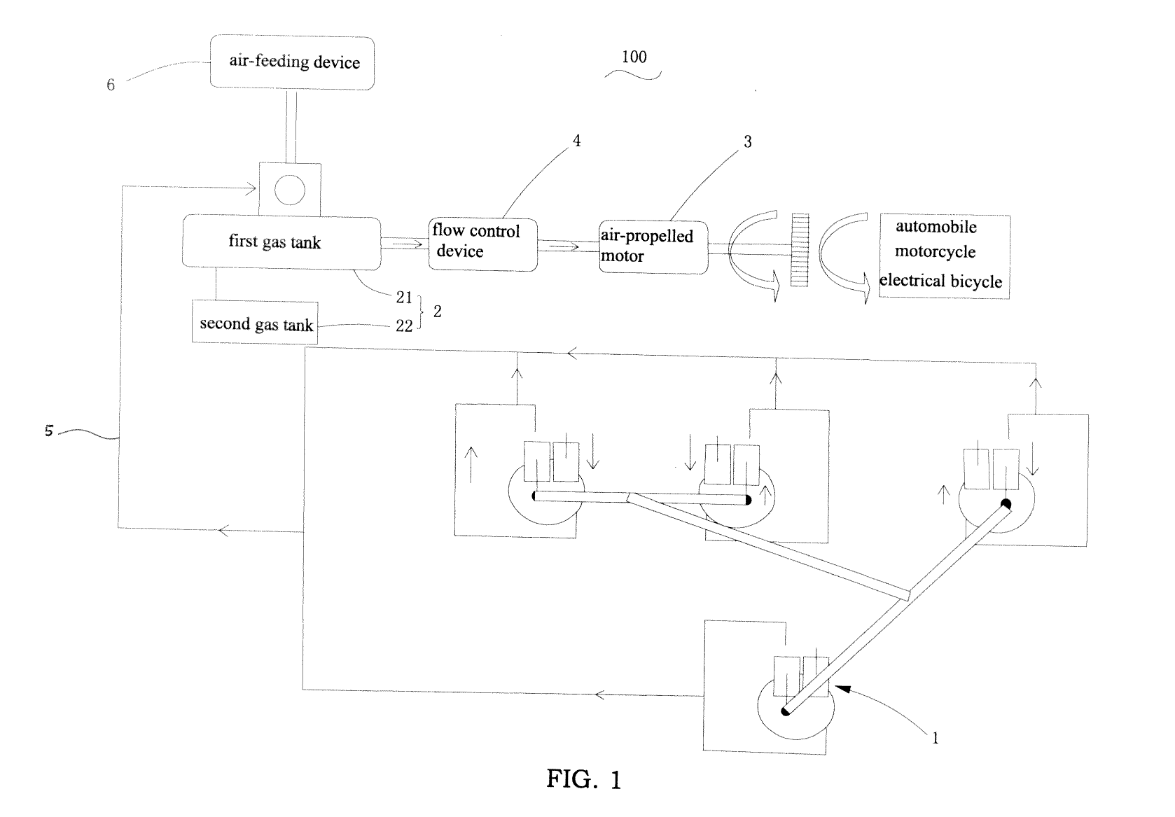

Referring to FIG. 1, an embodiment of a vehicle 100 according to the present disclosure is driven by compressed air, which includes an air-propelled system. The vehicle 100 may be an automobile, a motorcycle or a electrical bicycle, in the illustrated embodiment, the vehicle 100 is an automobile. The vehicle 100 may includes other conventional driven system powered by gasoline, diesel oil, electricity, natural gas, solar energy, bioenergy (e.g. alcohol or biodiesel), or nuclear energy.

The air-propelled system includes four air compressors 1, an air reservoir 2, an air-propelled motor 3, a flow control device 4, and a gas pipeline 5.

The four air compressors 1 are positioned between a body (not shown) and a wheel axle (not shown) of the vehicle 100. The vehicle 100 further includes four bumpers (not shown) positioned between the body and the wheel axle. Each air compressor 1 is positioned adjacent to one bumper to generate compressed air responding to vibrations of the wheel axle caused by irregularities in the road surface. Since the air compressor 1 is capable of absorbing shocks or vibrations, the four bumpers can be omitted.

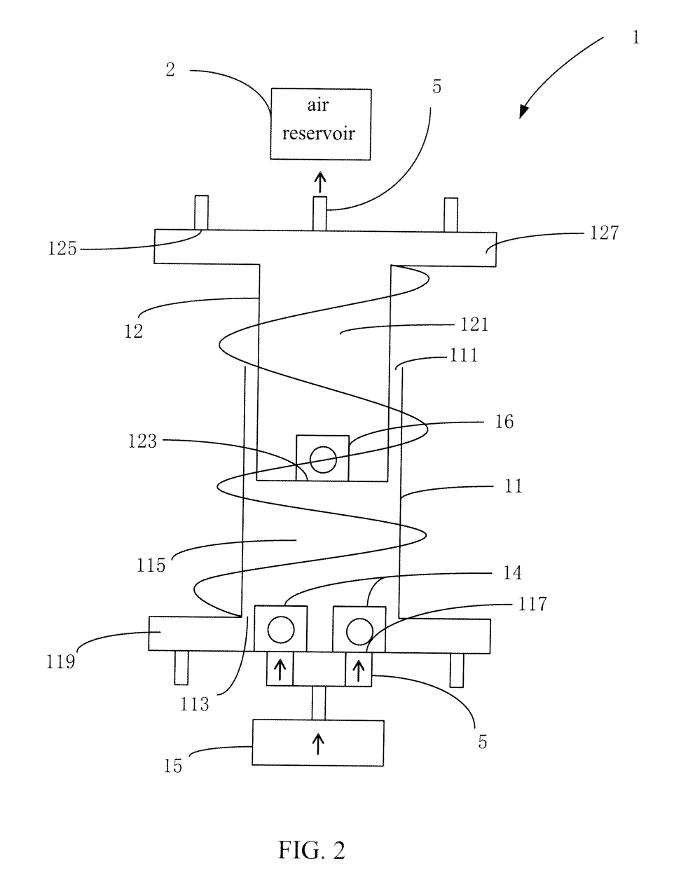

Referring to FIG. 2, each air compressor 1 includes a cylinder 11, a piston 12, and a spring 13.

The cylinder 11 has an open end 111 and a closed end 113 and defines a first cavity 115 communicating with the open end 111. The cylinder 11 further defines two first inlets 117 at the closed end 113 and includes a first flange 119 extending substantially perpendicularly to the closed end 13. The air compressor 1 further includes two first check valves 14 positioned corresponding to two first inlets 117. Each first check valve 14 is configured to be opened only to the first cavity 115, in other words, air can flow form the atmosphere to the first cavity 115 through the first check valve 14, but cannot flow back form the first cavity 115 to the atmosphere. The air compressor 1 further includes an air filter 15 connected to the first check valve 14 via the gas pipeline 5.

The piston 12 is shaped as a substantially hollow cylinder with two closed ends and defines a second cavity 121 in a middle portion thereof. The piston 12 is slidably inserted in the first cavity 115 of the cylinder 11 through the open end 111. The air compressor 1 further includes a seal ring (not shown) and lubricating oil positioned between the piston 12 and the cylinder 11 to fill a gap (not labeled) formed therebetween. The piston 12 defines a second inlet 123 at an end thereof facing the cylinder 11, and three outlets 125 at the other end thereof away from the cylinder 11. The air compressor 1 further includes a second check valve 16 positioned at the second inlet 123. The second check valve 16 is configured to be opened only to the second cavity 121, in other words, air can flow form the first cavity 115 to the second cavity 121 through the second check valve 16, but cannot flow back form the second cavity 121 to the first cavity 115. The piston 12 further includes a second flange 127 extending substantially perpendicularly to the other end thereof away from the cylinder 11. The spring 13 is located between the first flange 119 and the second flange 127.

In use, the spring 13 is compressed by an external force, and the piston 12 linearly reciprocates inside the first cavity 115 of the cylinder 11. The first check valve allows the air flow form the atmosphere to the first cavity 115 of the cylinder 11, and the second check valve allows the air flow from the first cavity 115 of the cylinder 11 to the second cavity 121 of the piston 12, thus air pump capable of generating compressed air is formed. The air compressor 1 is very sensitive to vibrations or shocks of the vehicle 100, and it can convert those vibrations or shocks into compressed air.

In the illustrated embodiment, four air compressors 1 can be divided into two pairs of the air compressors 1. The two cylinders 11 of the first pair of the air compressors 1 is located at the wheel axle of the vehicle 100, and the two pistons 12 of the first pair of the air compressors 1 is located at the body of the vehicle 100. The two cylinders 11 of the second pair of the air compressors 1 is located at the body of the vehicle 100, and the two pistons 12 of the first pair of the air compressors 1 is located at the wheel axle of the vehicle 100. Thus, the four air compressors 1 can convert the vibrations or shocks from all directions of the vehicle 100 into compressed air.

The air reservoir 2 is connected to the three outlets 125 of the piston 12 via the gas pipeline 5. The air reservoir 2 includes a first gas tank 21 and a second gas tank 22. The first gas tank 21 is connected to the air-propelled motor 3 and can supply compressed air to the air-propelled motor 3. The second gas tank 22 is connected to other electrical equipments of the vehicle 100, such as air-propelled generator. The vehicle 100 further includes an air-feeding device 6 connected to the air reservoir 2, which may be an electrical air pump or a manual air pump, to fill the air reservoir 2 with compressed air used to start the vehicle 100. It should be noted that, the air reservoir 2 may be connected to external air sources to fill in compressed air.

The air-propelled motor 3 is connected to the first gas tank 21 via the gas pipeline 5. In the illustrated embodiment, the air-propelled motor 3 is a turbine motor.

The flow control device 4 is positioned between the air reservoir 2 and the air-propelled motor 3. The flow control device 4 may be controlled by a user's hand or foot. It is to be understood that, the flow control device 4 may be omitted.

Although the invention has been described in language specific to structural features and/or methodological acts, it is to be understood that the invention defined in the appended claims is not necessarily limited to the specific features or acts described. Rather, the specific features and acts are disclosed as sample forms of implementing the claimed invention.

What is claimed is:

1. A vehicle, driven by compressed air, comprising:
at least one air compressor, positioned between a body and a wheel axle of the vehicle, configured to generate compressed air responding to vibrations of the wheel axle caused by irregularities in the road surface;
an air reservoir, connected to the air-compressor, configured to reserve the compressed air;
an air-propelled motor, connected to the air reservoir, driven by the compressed air.

2. The vehicle according to claim 1, further comprising a bumper positioned between the body and the wheel axle, the at least one air compressor is positioned adjacent to the bumper.

3. The vehicle according to claim 1, wherein the at least one air compressor comprises:
a cylinder, the cylinder has an open end and a closed end and defines a first cavity therein communicating with the open end, the cylinder further defines a first inlet at the closed end;
a piston, the piston is received in the cylinder through the open end and defines a second cavity, the piston defines a second inlet at an end thereof facing the cylinder and an outlet at the other end thereof away form the cylinder, the second inlet and the outlet are communicating with the second cavity, the outlet is communicating with the air reservoir;
a spring, positioned between the cylinder and the piston.

4. The vehicle according to claim 3, further comprising a first check valve positioned at the first inlet, the first check valve can only be opened to the first cavity.

5. The vehicle according to claim 3, further comprising a second check valve positioned at the second inlet, the second check valve can only be opened to the second cavity.

6. The vehicle according to claim 3 wherein the cylinder comprises a first flange extending outwards form the closed end, the piston comprises a second flange extending outwards form the other end away form the cylinder, the spring is located between the first flange and the second flange.

7. The vehicle according to claim 3, comprising two air compressors, the cylinder of one air compressor is located at the wheel axle and the piston of the one air compressor is located at the body; the cylinder of the other air compressor is located at the body and the piston of the other air compressor is located at the wheel axle.

8. The vehicle according to claim 1, wherein the air reservoir comprises a first gas tank and a second gas tank, the first gas tank is connected to the air-propelled motor, the vehicle further comprises electrical equipments, the second gas tank is connected to the electrical equipments.

9. The vehicle according to claim 1, further comprising an air-feeding device connected to the air reservoir, the air-feeding device including an electrical air pump or a manual air pump.

10. The vehicle according to claim 1, further comprising a flow control device positioned between the air reservoir and the air-propelled motor.

11. The vehicle according to claim 1, wherein the air-propelled motor is a turbine motor.

12. The vehicle according to claim 1, further comprising a drive system powered by any one of gasoline, diesel oil, electricity, natural gas, solar energy, bioenergy, nuclear energy, or any combination of any two or more of the preceding.

13. The vehicle according to claim 1, wherein the vehicle is a automobile or a motorcycle or a electric bicycle.

14. An air compressor, positioned between a body and a wheel axle of a vehicle, configured to generate compressed air responding to vibrations of the wheel axle caused by irregularities in the road surface.

15. The air compressor according to claim 14, wherein the vehicle further comprises a bumper positioned between the body and the wheel axle, the air compressor is positioned adjacent to the bumper.

16. The air compressor according to claim 14, comprises:
a cylinder, the cylinder has an open end and a closed end and defines a first cavity communicating with the open end, the cylinder further defines a first inlet at the closed end;
a piston, the piston is received in the cylinder through the open end and defines a second cavity, the piston defines a second inlet at an end thereof facing the cylinder and an outlet at the other end thereof away form the cylinder, the second inlet and the outlet are communicating with the second cavity, the outlet is communicating with the air reservoir;
a spring, positioned between the cylinder and the piston.

17. The air compressor according to claim 16, further comprising a first check valve positioned at the first inlet, the first check valve can only be opened to the first cavity.

18. The air compressor according to claim 16, further comprising a second check valve positioned at the second inlet, the second check valve can only be opened to the second cavity.

19. The air compressor according to claim 16, wherein the cylinder comprises a first flange extending outwards form the closed end, the piston comprises a second flange extending outwards form the other end away form the cylinder, the spring is located between the first flange and the second flange.

20. The air compressor according to claim 16, wherein the number of the air compressor is two, the cylinder of one air compressor is located at the wheel axle and the piston of the one air compressor is located at the body; the cylinder of the other air compressor is located at the body and the piston of the other air compressor is located at the wheel axle.
